(19) United States
(12) Patent Application Publication
(10) Pub. No.: US 2015/0096971 A1
(43) Pub. Date: Apr. 9, 2015

(54) Interchangeable Wrap Slow Cooker

(71) Applicant: HAMILTON BEACH BRANDS, INC., Glen Allen, VA (US)

(72) Inventors: David Matthew Schandel, Henrico, VA (US); Marta Phillips, Midlothian, VA (US)

(21) Appl. No.: 14/337,542

(22) Filed: Jul. 22, 2014

Related U.S. Application Data
(60) Provisional application No. 61/887,105, filed on Oct. 4, 2013.

(51) Int. Cl. A47J 27/00; A47J 27/62; G09F 7/00

(52) U.S. Cl. CPC A47J 27/004; G09F 7/00; A47J 27/62; G09F 2023/0025
USPC 219/442

(57) ABSTRACT

A kitchen appliance comprises a housing including a base member, a side wall member, and a retaining trim encasing the upper end of the side wall. The side wall member includes an external enclosure and an internal liner. At least a portion of the retaining trim is spaced radially outwardly from an external surface of the enclosure, thereby defining a retaining channel between the retaining trim and the external surface of the enclosure. The kitchen appliance includes at least one decorative panel for lining at least a portion of the external surface of the enclosure. An upper end of the panel is slidably receivable into, and retainable by, the retaining channel and a lower end of the at least one decorative panel is supported by the base member. The panel is disengageable from the retaining channel and the base member, such that the panel is interchangeable.

### CROSS-REFERENCE TO RELATED APPLICATIONS

The present application claims the benefit of U.S. Provisional Application No. 61/887,105, filed Oct. 4, 2013 and titled “Kitchen Appliance with Interchangeable Decorative Panels,” the subject matter of which is expressly incorporated by reference herein.

### BACKGROUND OF THE DISCLOSURE

The present disclosure is directed to a kitchen appliance, such as a slow cooker, and more particularly to a kitchen appliance having at least one decorative panel lining the kitchen appliance, that is interchangeable.

Kitchen appliances are often a staple fixture in an individual's kitchen. Many kitchen appliances are placed on a kitchen countertop, or a kitchen table, and remain there regardless of frequency of use. Such kitchen appliances may even be considered as part of the kitchen décor. One drawback associated with conventional kitchen appliances is that manufacturers are generally primarily concerned with improving the functionality of the appliance, while generally neglecting the aesthetic appearance of the appliance. Consequently, conventional kitchen appliances are often generally aesthetically dull.

Some manufacturers have attempted to improve the aesthetic appearance of a kitchen appliance by providing the appliance in a variety of different colors, or by utilizing glass components. Alternatively, in rare instances, some kitchen appliances may even have a design on the outer casing of the appliance. However, one drawback associated with such attempts at improving the aesthetic appearance of the appliance is that they are permanent. Therefore, a user cannot change the color or design depending on, for example, the season, an event, a change in the color of the kitchen, or merely if the user desires a change. The user's sole option in such an instance is to re-purchase the appliance in a different color or with a different design.

Therefore, it would be advantageous to manufacture kitchen appliances having an improved aesthetic appearance. It would be further advantageous to manufacture kitchen appliances having panels that line the outer casing of the appliance that are interchangeable. Such panels may have different colors, designs and/or decorations, such that a user may merely purchase different panels to change the aesthetic appearance of the appliance.

### BRIEF SUMMARY OF THE DISCLOSURE

Briefly stated, one aspect of the present disclosure is directed to a kitchen appliance. The kitchen appliance comprises a housing including a base member, a side wall member extending upwardly from the base member to an opposing open upper end and a retaining trim encasing the upper end. The side wall member comprises an external enclosure and an internal liner. The internal liner defines a cavity therein. At least a portion of the retaining trim is spaced radially outwardly from an external surface of the enclosure, thereby defining a first retaining channel between the retaining trim and the external surface of the enclosure. The kitchen appliance further comprises at least one decorative panel configured for lining at least a portion of the external surface of the enclosure. An upper end of the at least one decorative panel is slidably receivable into, and retainable by, the first retaining channel and a lower end of the at least one decorative panel is supported by the base member. The at least one decorative panel is disengageable from the first retaining channel and the base member, such that the at least one decorative panel is interchangeable.

In accordance with another aspect, the present disclosure is to a direction to a kitchen appliance. The kitchen appliance comprises a housing including a base member, a side wall member extending upwardly from the base member to an opposing open upper end and a retaining trim encasing the upper end. The side wall member comprises an external enclosure and an internal liner. The internal liner defines a cavity therein. At least one of a heating and cooling element is disposed within the housing to heat or cool the cavity. A vessel is removably receivable within the liner cavity, having a hollow interior for receiving foodstuff therein and an open top end for accessing the interior. A lid is configured to at least partially cover the open top end of the vessel when placed thereon. At least a portion of the retaining trim is spaced radially outwardly from an external surface of the enclosure, thereby defining a first retaining channel between the retaining trim and the external surface of the enclosure. The kitchen appliance further comprises at least one decorative panel configured for lining at least a portion of the external surface of the enclosure. An upper end of the at least one decorative panel is slidably receivable into, and retainable by, the first retaining channel and a lower end of the at least one decorative panel is supported by the base member. The at least one decorative panel is disengageable from the first retaining channel and the base member, such that the at least one decorative panel is interchangeable. At least one handle is mounted to the enclosure by which a user may engage the appliance.

### BRIEF DESCRIPTION OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a front perspective view of a kitchen appliance according to a first embodiment of the present disclosure, having an interchangeable decorative panel mounted thereon;

FIG. 2 is a front elevational view of the kitchen appliance of FIG. 1, prior to mounting an interchangeable decorative panel thereon;

FIG. 3 is a bottom perspective view of the kitchen appliance of FIG. 1, showing mounting of an interchangeable decorative panel onto the kitchen appliance;

FIG. 4 is an enlarged partial cross-sectional view of a portion of the kitchen appliance of FIG. 1, showing a side wall member of the kitchen appliance and a vessel received into the kitchen appliance;

FIG. 5A; is a front view of an alternative embodiment of a retaining tab of a base member of the kitchen appliance of FIG. 1, in a locked, panel engaging position

FIG. 5B; is a front view of the retaining tab of FIG. 6A, in an unlocked, panel disengaging position;

FIG. 6A is a cross-sectional view of the base member of the kitchen appliance according to a second embodiment, prior to engaging an interchangeable decorative panel with the base member;

FIG. 6B is a cross-sectional view of the base member of the kitchen appliance of FIG. 7A, after engaging an interchangeable decorative panel with the base member;

FIGS. 7A-7C are sequential views of the steps involved in mounting an interchangeable decorative panel onto the kitchen appliance of FIG. 7A.

### DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the slow cooker, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

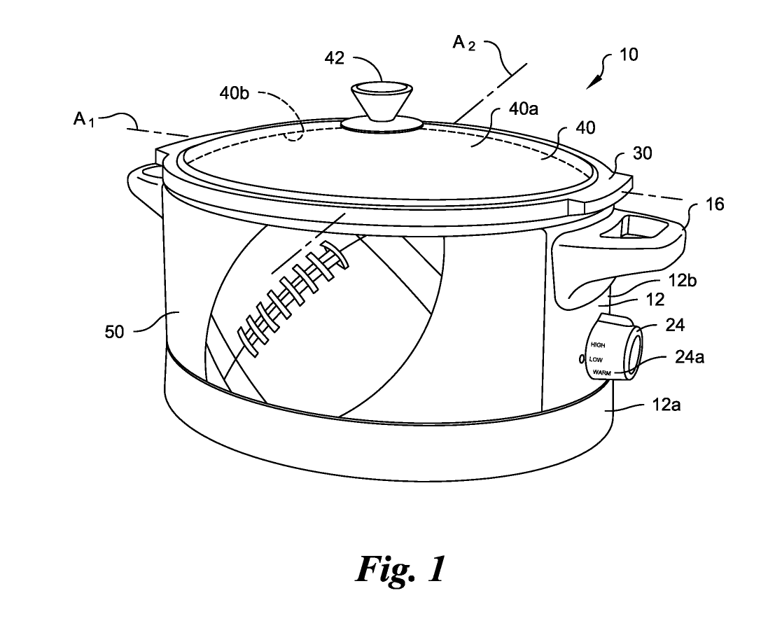

Referring to the drawings in detail, wherein like numerals indicate like elements throughout, there is shown in FIGS. 1-6B a kitchen appliance, generally designated 10, according to a first embodiment of the present disclosure. The kitchen appliance 10 is illustrated as a slow cooker for warming and/or cooking (collectively referred to as heating) contents (none shown), such as foodstuff or another object, therein. However, the present disclosure is not limited to such a device or functionality. For example, the kitchen appliance 10 may be any of a variety of devices typically used in a kitchen, such as, for example, without limitation, a deep fryer, a roaster oven, or any type of device having a lid and a vessel, as described in detail below. The term “foodstuff,” as used herein, is sufficiently broad to cover any substance that is capable of being consumed by a user, such as, for example, without limitation, a pork roast, vegetables, water, milk or the like, or any combination thereof. The kitchen appliance 10 is also capable of heating or cooling one or more objects (not shown) other than foodstuff, such as, for example, without limitation, a baby's bottle, one or more stones or towels for a massage, or the like.

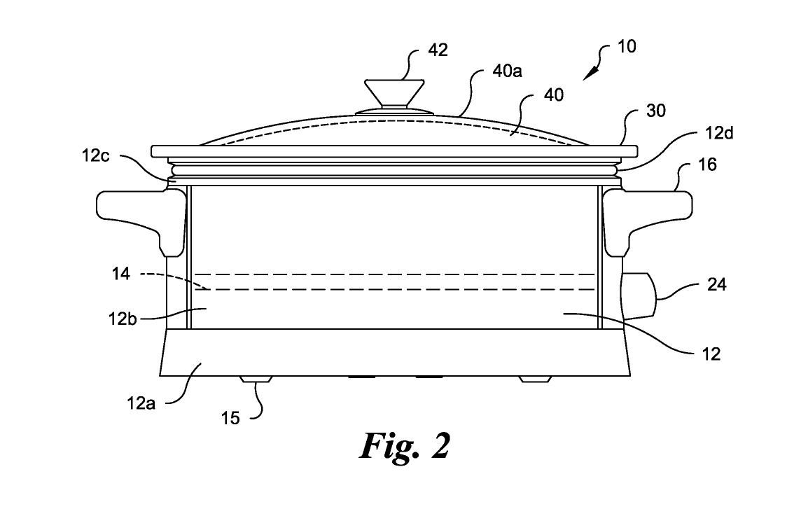

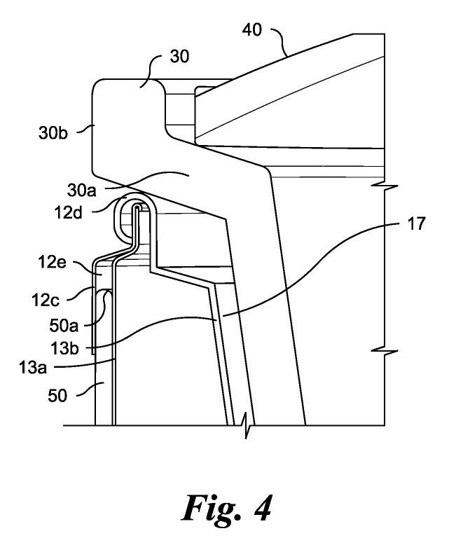

Referring to FIGS. 1 and 2, the kitchen appliance 10 includes a housing 12 having a base member 12a, a side wall member 12b extending from the base member 12a to an opposing open upper end of the housing 12, and a retaining trim 12c encasing the upper end. In the illustrated embodiment, the side wall member 12b extends generally perpendicularly to the base member 12a. However, as should be understood by those of ordinary skill in the art, the side wall member 12b may extend at an obtuse or acute angle to the base member 12a. As shown in FIG. 4, the side wall member 12b includes an external enclosure 13a facing and/or exposed to the external environment and an opposing internal liner 13b. At least portions of the internal liner 13b of the side wall member 12b and an interior or upper surface of the base member 12a surround and/or define a cavity 17 of the housing 12. As shown in FIG. 2, the upper edge of the internal liner 13b defines an upper housing rim 12d at an upper edge of the side wall member 12b. The housing rim 12d surrounds and/or defines an opening to the cavity 17 of the housing 12.

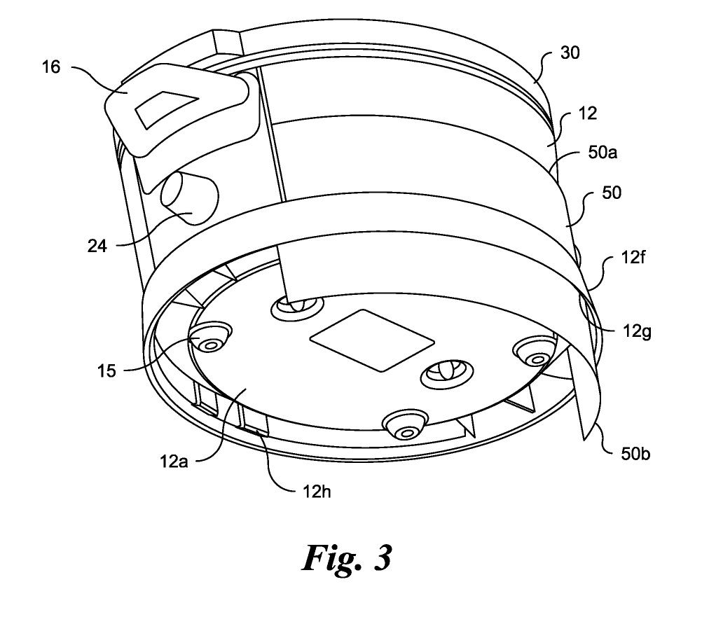

As shown, the base member 12a, the side wall member 12b and the retaining trim 12c are generally ovular or elliptical in shape in plan view. Thus, the housing 12 has a major axis A₁ and a minor axis A₂ (FIG. 1). The minor axis A₂ extends at least generally perpendicularly to the major axis A₁. “Front” and “rear” sides of the housing 12 are located on opposing sides of the major axis A₁. “Left” and “right” sides of the housing 12 are located on opposing sides of the minor axis A₂. As should be understood, however, the base member 12a may have a different shape, such as, but not limited to, circular or rectangular in plan view. As shown in FIGS. 2 and 3, the base member 12a may include a plurality of generally spaced-apart, rounded protrusions or feet 15 extending downwardly from a bottom surface of the base member 12a for supporting the kitchen appliance 10 on an underlying support surface (not shown), such as a countertop, and spacing the bottom surface of the base member 12a at least slightly above the support surface. Alternatively, the kitchen appliance 10 may include no feet, such that the kitchen appliance 10 is supported by the bottom surface of the base member 12a directly on the underlying support surface.

As shown in FIG. 2, a heating or cooling element 14 (shown in phantom) is disposed within the housing 12 proximate the cavity 17 to heat and/or cool the cavity 17. The heating or cooling element 14 may be located within or on the internal liner 13b of the side wall member 12b of the housing 12, or may be disposed within the base member 12a of the housing 12 in addition to, or instead of, the side wall member 12b. The heating or cooling element 14 may be electrically powered. In some embodiments, the heating or cooling element 14 is a resistance-type heating element, such as a calrod or mica board heating element. However, as should be understood by those of ordinary skill in the art, different types of heating or cooling elements may be used, provided the heating or cooling element functions to heat and/or cool the cavity 17 of the housing 12.

As shown in FIGS. 1-3, the kitchen appliance 10 also includes at least one handle 16 mounted to and extending outwardly and/or upwardly from the external enclosure 13a of the side wall member 12b of the housing 12. As illustrated, the kitchen appliance 10 includes two handles 16 mounted to and extending outwardly from the left and right sides of the housing 12, respectively. That is, the two handles 16 are diametrically opposed in relation to one another and are disposed along the major axis A₁ of the housing 12. As should be understood by those of ordinary skill in the art, the handles 16 are not limited to such an orientation or configuration, as the handles 16 may alternatively be disposed along the minor axis A₂ of the housing 12 or at a position therebetween. The handles 16 allow the kitchen appliance 10 to be relatively easily lifted and/or transported.

As shown, a control knob 24 extends outwardly from the side wall member 12b of the housing 12 to enable a user to control the heating or cooling element 14. In the illustrated embodiment, the control knob 24 is located on one of the left and right sides of the kitchen appliance 10, beneath one of the handles 16. Thus, the control knob 24 is operatively connected to the heating or cooling element 14. The control knob 24 includes setting markings 24a on the control knob 24. In some embodiments, the setting markings 24a may be printed on control knob 24. However, as should be understood, the setting markings 24a may be placed on the control knob 24 via any conventional means. Rotation of the control knob 24 by a user toggles the heating or cooling element 14 between the settings. Settings include at least one “on” setting and an “off” setting. In the illustrated embodiment, the heating or cooling element 14 has two “on” settings, a “high” heat setting and a “low” heat setting. The setting markings 24a are located on both sides of the control knob 24 (not shown), so that either side of the control knob 24 can face a user, thereby allowing a user to determine which direction to rotate the control known 24 to achieve a desired setting. Accordingly, either side of the kitchen appliance 10 can be utilized by a user as the “front” side, and the opposing side can be the “rear” side. That is, since the setting markings 24a are located on both sides of the control knob 24, the kitchen appliance 10 can be rotated so that the control knob 24 is on the right side or on left side. However, it is further contemplated that alternate configurations of the control knob 24 may be used, such as, for example, but not limited to, rotation of the control knob 24 to actuate a thermostat (not shown) to a specific user selected temperature, for heating or cooling element 14 to heat and/or cool the cavity 17 of the housing 12 to the user selected temperature. The kitchen appliance 10 is also not limited to the size, shape, configuration and/or functionality of the control knob 24 shown and described herein. In other embodiments, for example, the kitchen appliance 10 may include a control interface (not shown), with one or more buttons, switches or the like, in addition to or in place of the control knob 24 to allow more advanced control of the kitchen appliance 10.

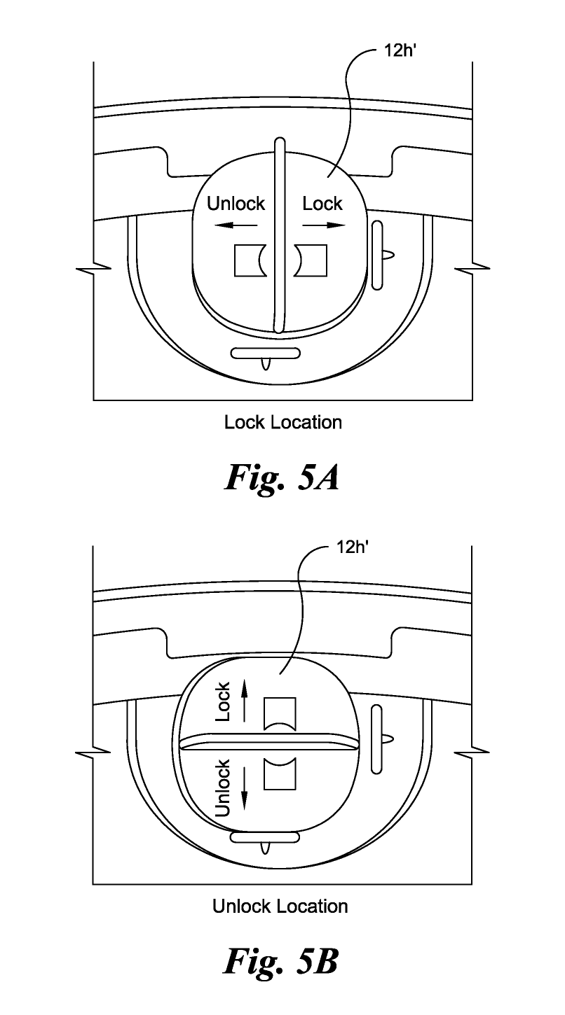

As shown best in FIGS. 1, 2 and 4, the kitchen appliance 10 also includes a vessel 30, having a generally hollow interior, sized and/or shaped to fit within the cavity 17 of the housing 12 for heating and/or cooling of the vessel 30 by the heating or cooling element 14. More specifically, an exterior of the vessel 30 is at least slightly smaller than the interior of the cavity 17 of the housing 12, such that at least a majority of the vessel 30 fits within the cavity 17 of the housing 12. In the illustrated embodiment, as shown best in FIGS. 4 and 5, the upper end of the vessel 30 defines a generally laterally outwardly projecting lip 30a, adapted to rest atop the housing rim 12d when the vessel 30 is placed within the cavity 17 of the housing 12. As shown, the lip 30a extends past the housing rim 12d, thereby defining a shoulder that a user may engage to lift and remove the vessel 30 from the cavity 17 of the housing 12. In the illustrated embodiment, the vessel 30 also includes a rim 30b extending generally perpendicularly upwardly from the lip 30a. The vessel rim 30b defines an opening for accessing the interior of the vessel 30. The interior of the vessel 30 is capable of retaining the foodstuff or other contents therein. In some embodiments, the vessel 30 is constructed of stoneware or ceramic. However, the vessel 30 may be made of a different material, such as, for example, without limitation, cast iron with a porcelain enamel coating, provided the container 30 is capable of functioning as described herein. Additionally, it is preferable that the vessel 30 be easily removable from the housing 12 to facilitate cleaning of the vessel 30, without exposing the housing 12, and specifically the heating or cooling element 14 and other electrical components thereof, to water and/or cleaning detergents or solvents.

As shown best in FIGS. 1 and 2, the kitchen appliance 10 preferably includes a lid 40 sized and shaped to cover the opening of the vessel 30 when the lid 40 is placed on, or adjacent to, the vessel rim 30b. In the illustrated embodiment, as shown in FIG. 4, the vessel lip 30a and the vessel rim 30b define a pocket, wherein the lip 30a functions as a ledge supporting the lid 40 and the rim 30b generally encases the lid 40 to secure the position of the lid 40 atop the vessel 30 and mitigate accidental slippage of the lid 40 off of the vessel 30. The lid 40 includes a top or exterior surface 40a and an opposing bottom or interior surface 40b that faces the interior of the vessel 30 when the lid 40 is placed on or adjacent to the vessel rim 30b. In the illustrated embodiment, a generally centrally disposed lid handle or knob 42 extends outwardly or upwardly from the exterior surface 40a of the lid 40. As shown, the lid 40 has an at least slightly arcuate shape, such that the exterior surface 40a is generally convex and the interior surface 40b is generally concave. Alternatively, at least one or both of the exterior surface 40a and the interior surface 40b of the lid 40 may be at least partially or entirely flat. In some embodiments, the lid 40 is predominantly made of glass, although the lid 40 may alternatively be made of a different material, e.g., a different transparent or translucent material, such as, for example, a polymeric material, provided the lid 40 functions as described herein.

In the illustrated embodiment, the lid 40 is generally ovular or elliptical when viewed from above or below to correspond to or at least generally match the shape of the opening of the vessel 30. As shown, the lid 40 covers the entire opening of the vessel 30 when placed on the vessel rim 30b, such that an entire outer periphery of the lid 40 engages and/or is positioned adjacent to the vessel rim 30b. In the illustrated embodiment, the lid 40 is shown having an outer periphery and a diameter that is at least slightly smaller than an outer periphery and a diameter of the vessel rim 30b, because at least a portion of the outer periphery of the lid 40 rests on the ledge 30a at least slightly inwardly from the outer periphery of the vessel 30. However, in alternative embodiments, the outer periphery of the lid 40 may match or be about the same size as or slightly larger than the outer periphery of the vessel 30.

In some embodiments, the handles 16 are configured to seal and/or lock the lid 40 onto the vessel 30 to prevent leakage of the contents within the vessel 30. In some embodiments, a gasket is placed preferably around and/or below one of the outer periphery or edge of the lid 40 and the vessel 30 for sealing the lid 40 to the vessel 30. The gasket may be formed of a resiliently flexible material, such as an elastomeric or rubber material, and is preferably at least slightly compressible to create at least a generally liquid-tight seal between the lid 40 and the vessel rim 30 when the lid 40 is properly placed on the vessel 30. The handles and gasket may be, for example, as those disclosed in U.S. patent application Ser. No. 13/476,080, filed on May 21, 2012, entitled “Kitchen Appliance and Method of Using Same,” and U.S. patent application Ser. No. 14/080,343, filed, Nov. 14, 2013, entitled “Kitchen Appliance with Locking Handles,” each of which is hereby incorporated by reference in its entirety.

As shown, an interchangeable decorative panel 50 is mountable to the kitchen appliance 10 for lining at least a portion of the “front” and/or “rear” sides of the external enclosure 13a. When mounted, an upper end 50a of the decorative panel is retained by the retaining trim 12c, and a base end 50b of the decorative panel 50 is supported by the base member 12a. In some embodiments, the decorative panel 50 is constructed of a metal or a polymer. In some embodiments, a decorative design is printed directly onto the panel 50. Alternatively, the decorative design may be printed onto a PET film that is bonded onto the panel 50. As should be understood by those of ordinary skill in the art, any of numerous different decorative designs or colors may be on the panel 50. For example, without limitation, the decorative design may be a sports design or sports team logo, a seasonal design, a color or variety of colors, or a custom personalized picture printed onto the panel 50.

As shown in FIG. 4, the retaining trim 12c is secured to the housing 12 between the external enclosure 13a and in the internal liner 13b. Namely, an upper end of the retaining trim 12c overlies the upper end of the external enclosure 13a and depends therefrom, and the upper rim of the internal liner 13b overlies the upper end of the retaining trim 12c, thereby securing the retaining trim 12c between the enclosure 13a and the liner 13b. At least a portion of the retaining trim 12c is spaced radially away from the external enclosure 13a, thereby defining a first retaining channel 12e between the retaining trim 12c and the enclosure 13a, dimensioned to receive the upper end 50a of a decorative panel 50. In some embodiments, the retaining trim 12c is constructed of a stamped metal piece. In some embodiments, the retaining trim 12c is constructed of brushed stainless steel or chrome. In some embodiments, the retaining trim 12c may frictionally receive the upper end 50a of a decorative panel 50 to minimize movement of the decorative panel 50 when lining the external enclosure 13a of the kitchen appliance 10. In some embodiments, the first retaining channel 12e may alternatively, or additionally, be dimensioned to create a dimensional interference with the thickness of a decorative panel 50 to also minimize movement of the decorative panel 50.

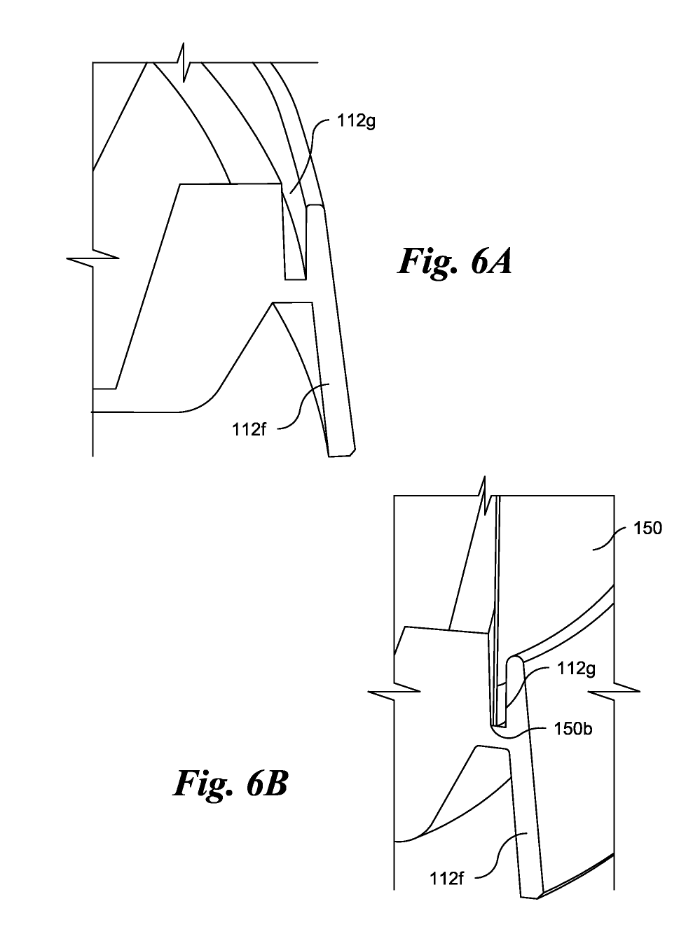

As shown in FIG. 3, the base member 12a includes a base trim 12f encasing a base end of the side wall member 12b, and spaced radially away from the base member 12a and the external enclosure 13a, at least along the front and rear sides of the housing 12. The base member 12a defines a second channel 12g between the base trim 12f and the enclosure 13a, having open upper and base ends, such that the decorative panel 50 may slide through the second channel 12g. The base member 12a also includes at least one retaining tab 12h projecting downwardly from the base member 12a in a direction toward the underlying support surface, configured to engage and support the base end 50b of the decorative panel 50. The at least one retaining tab 12h is sized to not interfere with placement of the kitchen appliance 10 on an underlying support surface. In the illustrated embodiment, the base member 12a includes a plurality of retaining tabs 12h configured to releasably snap over the base end 50b of the decorative panel 50 to support the decorative panel 50 in place. However, as should be understood by those of ordinary skill in the art, the retaining tabs 12h may take the form of any retaining member currently known, or that later become known, and which is capable of performing the functions of the retaining tabs 12h as described herein, such as, for example, without limitation, the retaining tabs 12h′ as shown in FIGS. 6A and 6B. The retaining tabs 12h′ may be swiveled between a locked, panel engaging position (FIG. 5A), and an unlocked, panel disengaging position (FIG. 5B).

To mount a decorative panel 50 on the external enclosure 13a and line the front and/or rear side(s) of the kitchen appliance 10, the upper end 50a of the decorative panel 50 is manually slideable through the second channel 12g (upper end 50a first), as shown in FIG. 3, toward the first retaining channel 12e, to a position wherein the upper end 50a of the decorative panel 50 is received within, and retained by, the first retaining channel 12e. The base end 50b of the decorative panel 50 is engaged and supported by the retaining tabs 12h to secure the decorative panel 50 in place. Should a user desire to interchange the decorative panel 50 with another panel 50 and/or clean the external enclosure 13a underneath, the user may manually disengage the retaining tabs 12h from the base end 50b of the decorative panel 50 and slide the decorative panel 50 in reverse manner, away from the retaining trim 12c, through the second channel 12g and off of the kitchen appliance 10. In some embodiments, the decorative panel 50 may include at least one aperture adjacent the base end 50b of the decorative panel 50, for engagement by a user to assist in pulling the panel 50 through the second channel 12g and off of the kitchen appliance 10.

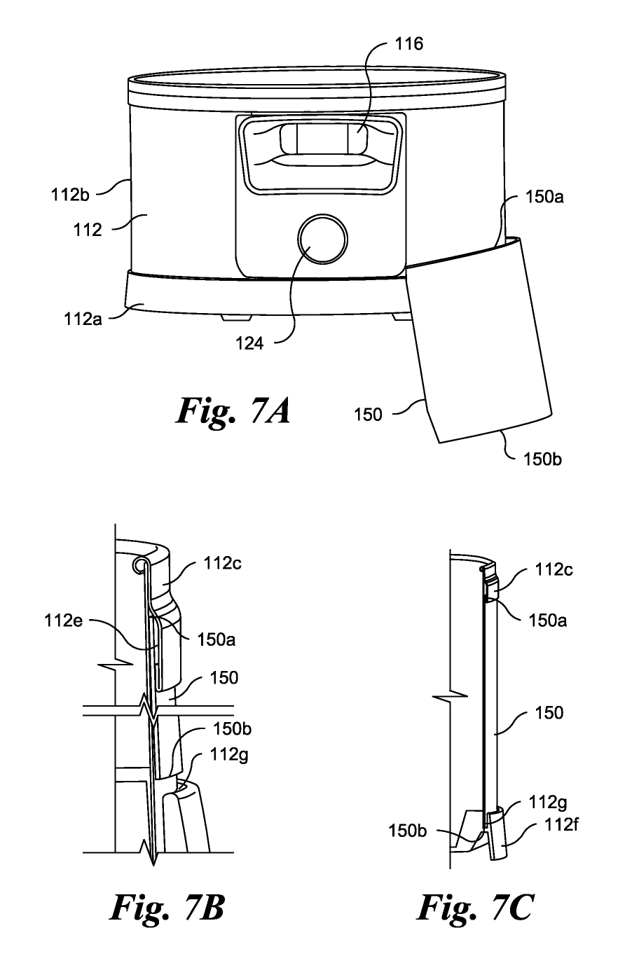

FIGS. 6A-7C show a second embodiment of the kitchen appliance 110. The reference numerals of the second embodiment are distinguishable from those of the first embodiment by a factor of one-hundred (100), but otherwise indicate the same elements as indicated in the first embodiment, except as otherwise specified. The kitchen appliance 110 of the second embodiment is substantially similar to that of the first embodiment. The description of certain similarities between the embodiments may be omitted herein for the sake of brevity and convenience, and, therefore, is not limiting.

A distinguishing feature of the second embodiment is that the base trim 112f defines a second retaining channel 112g having an open upper end and a closed base end, as shown in FIGS. 6A and 6B. Thus, a decorative panel cannot slide through the second retaining channel 112g. Rather, as shown in FIG. 7A, the decorative panel 150 is manually angularly slideable past the base trim 112f toward the first retaining channel 112e to a position wherein the upper end 150a of the decorative panel 150 is received within, and retained by, the first retaining channel 112e and the base end 150b of the decorative panel 150 is clear of the base trim 112f (FIG. 7B). As shown in FIG. 7c, the decorative panel is thereafter manually slideable toward the base trim 112f to a position wherein the base end 150b of the decorative panel is received within, and supported by, the second retaining channel 112g (FIG. 6B) while the upper end 150a of the decorative panel remains received within, and retained by, the first retaining channel 112e (FIG. 7C). To remove the panel 50, the reverse steps are performed.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

We claim:

1. A kitchen appliance comprising:
a housing including a base member, a side wall member extending upwardly from the base member to an opposing open upper end and a retaining trim encasing the upper end, wherein the side wall member comprises an external enclosure and an internal liner, the internal liner defining a cavity therein, and at least a portion of the retaining trim is spaced radially outwardly from an external surface of the enclosure, thereby defining a first retaining channel between the retaining trim and the external surface of the enclosure; and
at least one decorative panel configured for lining at least a portion of the external surface of the enclosure, wherein an upper end of the at least one decorative panel is slidably receivable into, and retainable by, the first retaining channel and a lower end of the at least one decorative panel is supported by the base member, and the at least one decorative panel is disengageable from the first retaining channel and the base member, such that the at least one decorative panel is interchangeable.

2. A kitchen appliance as defined in claim 1, wherein an upper rim of the retaining trim overlies an upper rim of the external enclosure of the side wall member.

3. A kitchen appliance as defined in claim 2, wherein an upper rim of the internal liner of the side wall member overlies the upper rim of the retaining trim, thereby securing the retaining trim between the liner and enclosure.

4. A kitchen appliance as defined in claim 1, wherein the base member comprises:
a base trim encasing a base end of the housing and at least partially spaced radially outwardly from the external surface of the enclosure, thereby defining a second channel between the base trim and the external surface, and
at least one retaining tab configured to engage and support the lower end of said at least one decorative panel;
such that the at least one decorative panel is slideable through the second channel toward the first retaining channel, to a position wherein the upper end of said at least one decorative panel is received within, and retained by, the first retaining channel and the lower end of said at least one decorative panel is engaged and supported by said at least one retaining tab for securing the at least one decorative panel lining the enclosure.

5. A kitchen appliance as defined in claim 4, wherein the at least one retaining tab is configured to snap over the lower end of said at least one decorative panel for releasable engagement thereof.

6. A kitchen appliance as defined in claim 4, wherein the at least one retaining tab is manually disengageable from the lower end of the at least one decorative panel, such that the at least one decorative panel is reversibly slideable away from said first retaining channel and through the second channel for disengagement from the kitchen appliance.

7. A kitchen appliance as defined in claim 6, wherein the at least one decorative panel includes at least one aperture adjacent the lower end thereof, configured for engagement by a user for pulling the at least one decorative panel in a direction away from the first retaining trim.

8. A kitchen appliance as defined in claim 1, wherein the base member comprises a base trim encasing a base end of the housing and at least partially spaced radially outwardly from the external surface of said enclosure, defining a second retaining channel therebetween having an open upper end and a closed base end;
such that the at least one decorative panel is angularly slideable over the base trim toward the first retaining channel to a position wherein the upper end of said at least one decorative panel is received within, and retained by, the first retaining channel and the lower end of said at least one decorative panel is clear of the base trim, and the at least one decorative panel is thereafter slideable toward the base trim to a position wherein the lower end of said at least one decorative panel is received within, and retained by, the second retaining channel and the upper end of said at least one decorative panel remains received within, and retained by, the first retaining channel.

9. A kitchen appliance as defined in claim 1, wherein the enclosure defines opposing front and rear sides and opposing left and right sides of the kitchen appliance, and the at least one decorative panel is configured for lining at least one of the front and rear sides, and the at least one handle is mounted on at least one of the left and right sides.

10. A kitchen appliance as defined in claim 9, further comprising a control knob extending outwardly from one of the left or right sides of the enclosure, beneath one of the at least one handle.

11. A kitchen appliance as defined in claim 10, wherein the control knob is operatively connected to the heating or cooling element and configured to enable a user to control the heating or cooling element.

12. A kitchen appliance as defined in claim 10, wherein the control knob includes temperature control markings on both front and rear sides on said knob.

13. A kitchen appliance as defined in claim 1, wherein the at least one decorative panel is constructed of a metal or a polymer.

14. A kitchen appliance as defined in claim 13, wherein the at least one decorative panel is constructed of a polymer, and wherein a decorative design is printed directly thereon.

15. A kitchen appliance as defined in claim 13, wherein the at least one decorative panel is constructed of a polymer, and further comprises a PET film bonded thereto having a decorative design printed thereon.

16. A kitchen appliance comprising:
a housing including a base member, a side wall member extending upwardly from the base member to an opposing open upper end and a retaining trim encasing the upper end, wherein the side wall member comprises an external enclosure and an internal liner, the internal liner defining a cavity therein, and at least a portion of the retaining trim is spaced radially outwardly from an external surface of the enclosure, thereby defining a first retaining channel between the retaining trim and the external surface of the enclosure;
at least one decorative panel configured for lining at least a portion of the external surface of the enclosure, wherein an upper end of the at least one decorative panel is slidably receivable into, and retainable by, the first retaining channel and a lower end of the at least one decorative panel is supported by the base member, and the at least one decorative panel is disengageable from the first retaining channel and the base member, such that the at least one decorative panel is interchangeable;
at least one of a heating and cooling element disposed within the housing to heat or cool the cavity;
a vessel removably receivable within the liner cavity, having a hollow interior for receiving foodstuff therein and an open top end for accessing the interior;
a lid configured to at least partially cover the open top end of the vessel when placed thereon, and
at least one handle mounted to the enclosure by which a user may engage the appliance.
